(19) United States
(12) Patent Application Publication
(10) Pub. No.: US 2005/0137724 A1
(43) Pub. Date: Jun. 23, 2005

(54) Adaptive observer and related method

(75) Inventors: Naira Hovakimyan, Blacksburg, VA (US); Anthony Calise, Atlanta, GA (US); Venkatesh Madyastha, Atlanta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Georgia Tech Research Corporation

(21) Appl. No.: 10/961,883

(22) Filed: Oct. 8, 2004

Related U.S. Application Data
(60) Provisional application No. 60/510,504, filed on Oct. 10, 2003.
(60) Provisional application No. 60/528,557, filed on Dec. 9, 2003.

(51) Int. Cl. G06G 7/00; G06F 15/18; G05B 13/02

(52) U.S. Cl. 700/48; 706/16; 706/26

(57) ABSTRACT

A disclosed apparatus comprises an adaptive observer that has an adaptive element to augment a linear observer to enhance its ability to control a nonlinear system. The adaptive element comprises a first, and optionally a second, nonlinearly parameterized neural network unit, the inputs and output layer weights of which can be adapted on line. The adaptive observer generates the neural network units' teaching signal by an additional linear error observer of the nominal system's error dynamics. The adaptive observer has the ability to track an observed system in the presence of unmodeled dynamics and disturbances. The adaptive observer comprises a delay element incorporated in the adaptive element in order to provide delayed values of an actual output signal and a control signal to the neural network units.

### CROSS-REFERENCE TO RELATED APPLICATIONS

This application claims priority benefits under 35 U.S.C. 119(e) to U.S. provisional application No. 60/510,504 filed Oct. 9, 2003 and U.S. provisional application No. 60/528,557 filed Dec. 9, 2003, both naming Anthony J. Calise, Naira Hovakimyan, and Venkatesh K. Madyastha as inventors. Both such provisional applications are incorporated herein by reference as if set forth in full herein.

### STATEMENT OF U.S. GOVERNMENT RIGHTS IN THE INVENTION

This invention was made with U.S. Government funding under contract no. F49620-01-1-0024 awarded by AFOSR. The U.S. Government has certain rights in the invention.

### FIELD OF THE INVENTION

The present invention is generally directed to system, apparatus, and method used to track, and optionally control, a system under observation. More specifically, the present invention is directed to a class of tracking systems that uses an adaptive observer to determine the error between an actual output of an observed system and an estimated output of the observed system to track, and optionally control, the observed system.

### BACKGROUND OF THE INVENTION

Adaptive observers used for state estimation of nonlinear systems have been the subject of much recent interest. Adaptive observers are important to numerous aspects of automated tracking systems, including state estimation, system identification, and output feedback control. Examples of these adaptive observers are disclosed by [1] G. Bastin and M. R. Gevers, Stable Adaptive Observer for Nonlinear Time-Varying Systems, IEEE Trans. Autom. Contr., 33(7):650-658, 1988; [2] H. K. Khalil, Adaptive output feedback control of nonlinear systems represented by input-output models. IEEE Trans. Autom. Contr., 41(2):177-188, 1996; [3] R. Marino and P. Tomei, Nonlinear Control Design: Geometric, Adaptive, & Robust, Prentice Hall, New Jersey, 1995; [4] A. Teel and L. Praly, Global stabilizability and observability imply semi-global stabilizability by output feedback, Syst. Contr. Lett., 22:313-325, 1994; [5] M. Krstic and P. V. Kokotovic, Adaptive nonlinear output-feedback schemes with Marino-Tomei controller, IEEE Trans. Autom. Contr., 41(2):274-280, 1996. However, these approaches impose assumptions that severely limit their domain of applicability. For example, some approaches require that the systems to be linear with respect to unknown parameters, and others require systems that can be transformed into output feedback form. The universal approximation property of neural networks has motivated identification and estimation schemes that relax the assumptions which limit domain of applicability of an adaptive-observer-based tracking system. For example, such relaxation schemes are disclosed in [6] K. S. Narendra and K. Parthasarathy, Identification and control of dynamical systems using neural networks, IEEE Transactions on Neural Neworks, 1:4-27, 1990; [7] U. Strobl, U. Lenz, and Schroder, Systematic design for a stable neural observer for a class of nonlinear systems, Conference on Control Applications, 1997; [8] R, Zhu, T. Chai, and C. Shao, Robust nonlinear adaptive observer design using dynamical recurrent neural networks, American Control Conference, 1997; [9] Y. Kim, F. L. Lewis, and C. Abdallah, A dynamic recurrent neural network based adaptive observer for a class of nonlinear systems, Automatica, 33(8): 1539-1543, 1998; [10] J. R. Vargas and E. Hemerly, Neural adaptive observer for general nonlinear system, American Control Conference, 2000; and [11] F. J. Choi and J. A. Farell, Adaptive observer backstepping control using neural networks, IEEE Transactions on Neural Networks, 12(5):1103-1112, 2001. The main challenge lies in defining an error signal for updating the neural network connection weights. The observer developed by [9] mentioned above introduces a strictly positive real (SPR) filter that enables definition of the neural network weights' adaptive laws in terms of only the available measurement error signal. However, the filter needed to satisfy the SPR condition may not always exist, particularly for systems with multiple outputs. In the approach of [10], the SPR restriction has been relaxed, and an approach is set forth that is applicable to general nonlinear processes. However, a major difference is that the approach in [9] augments an existing linear observer, whereas the approach in [10] does not. The adaptive laws in both approaches are limited to adapting only the NN output layer weights. It would be desirable to provide an adaptive observer for a control system that can be used to augment an existing linear controller, but without the imposition of the SPR condition. In addition, it would be desirable to provide an adaptive observer to augment an existing linear controller, in which both input and output connections weights of neural networks can be adapted in order to enhance the ability of the control system to adapt to changes in the observed system, its environment, or the tracking system incorporating the adaptive observer. In addition, it would be advantageous to provide an adaptive observer in which teaching signals used to adapt the input and output connection weights of the neural network could be generated by a simple linear filter. Also, it would be desirable to provide an adaptive observer in which ultimate boundedness of the error signal can be demonstrated. Furthermore, it would be desirable to provide an adaptive observer that is able to adapt and track an observed system effectively even in the presence of unmodeled dynamics and disturbances.

### SUMMARY OF THE INVENTION

This invention, in its various embodiments, overcomes the above-noted disadvantages and achieves benefits not attained in the prior art.

In one embodiment, the adaptive observer of the invention comprises an adaptive observer augmenting a linear observer to enhance its ability to track a nonlinear observed system. The adaptive element can comprise a first, and optionally also a second, nonlinearly parameterized neural network units, the inputs and output layer weights of which can be adapted on line. The neural networks' teaching signal can be generated by an additional linear error observer of the nominal observed system's error dynamics. The resulting adaptive element has the ability to track an observed system in the presence of unmodeled dynamics and disturbances. A time delay unit can be incorporated in the adaptive element in order to provide delayed values of an actual output signal and a control signal to the neural network units. The linear observer, adaptive observer including neural networks, error observer, and time delay unit may be collectively referred to as a tracking system. Boundedness of signals generated or influenced by the tracking system can be proven through Lyapunov's direct method.

In another more detailed embodiment of the invention, the adaptive observer comprises an error observer, first and second neural network units, and a time delay unit. The error observer is coupled to receive a tracking error signal z that is a difference between an estimated output signal ŷ and an actual output signal y of an observed system. The error observer generates an estimated adaptive error signal Ê based on the tracking error signal z. The error observer can be implemented as a linear filter. The first and second neural network units can each comprise nonlinearly parameterized neural networks. The first neural network unit is coupled to receive the estimated adaptive error signal Ê and adjusts its input and output connection weights \hat{M}_{f}^{T}, \hat{N}_{f}^{T} based on the estimated adaptive error signal Ê. Likewise, the second neural network unit is coupled to receive the estimated adaptive error signal Ê and adjusts its input and output connection weights M_{g}^{T}, N_{g}^{T} based on the estimated adaptive error signal Ê. The time delay unit is coupled to receive the actual output signal y and generates at least one delayed value y_{d} of the actual output signal y which the time delay unit provides as a vector signal μ to the first and second neural network units as an input. The first and second neural network units generate respective adaptive signals \hat{M}_{f}^{T}σ(\hat{N}_{f}^{T}μ) and \hat{M}_{g}^{T}σ(\hat{N}_{g}^{T}μ) based on the vector signal μ and respective connection weights \hat{M}_{f}^{T}, \hat{N}_{f}^{T}, \hat{M}_{g}^{T}, \hat{N}_{g}^{T}. The adaptive signals \hat{M}_{f}^{T}σ(\hat{N}_{f}^{T}μ) and \hat{M}_{g}^{T}σ(\hat{N}_{g}^{T}μ) are provided to the linear observer to improve its performance in the presence of nonlinearity in the observed system. The time delay unit can further receive a control signal u, generate at least one delayed value u_{d} thereof, and output the delayed value u_{d} to the first and second neural network units as part of the vector signal μ.

In another relatively detailed embodiment, a method of the invention comprises the steps of: receiving at an error observer a tracking error signal z that is a difference between an estimated output signal ŷ and an actual output signal y of an observed system; generating at the error observer an estimated adaptive error signal Ê based on the tracking error signal z; updating input and output connection weights \hat{M}_{f}^{T}, \hat{N}_{f}^{T} of a first neural network unit based on the estimated adaptive error signal Ê; updating input and output connection weights \hat{M}_{g}^{T}, \hat{N}_{g}^{T} of a second neural network unit based on the estimated adaptive error signal Ê; generating a delayed value y_{d} of at least the actual output signal y which the time delay unit provides as a vector signal μ to the first and second neural network units as inputs; generating adaptive signals \hat{M}_{f}^{T}σ(\hat{N}_{f}^{T}μ) and \hat{M}_{g}^{T}σ(\hat{N}_{g}^{T}μ) at respective first and second neural network units based on the delayed value y_{d}; and outputting the adaptive signals \hat{M}_{f}^{T}σ(\hat{N}_{f}^{T}μ) and \hat{M}_{g}^{T}σ(\hat{N}_{g}^{T}μ) to a linear observer that observes the observed system. In the method, the estimated adaptive error signal Ê can be generated by linearly filtering the tracking error signal z. The first and second neural network units can update respective connection weights \hat{M}_{f}^{T}, \hat{N}_{f}^{T}, \hat{M}_{g}^{T}, \hat{N}_{g}^{T} each comprising nonlinearly parameterized neural networks. The connection weights \hat{M}_{f}^{T}, \hat{N}_{f}^{T}, \hat{M}_{g}^{T}, \hat{N}_{g}^{T} can be updated on line as the observed system is under observation. The adaptive signals adaptive signals \hat{M}_{f}^{T}σ(\hat{N}_{f}^{T}μ) and \hat{M}_{g}^{T}σ(\hat{N}_{g}^{T}μ) can be output to a linear observer to augment the linear observer to improve its performance in the presence of nonlinearity in the observed system. Furthermore, the time delay unit further receives a control signal u, generates at least one delayed value u_{d} thereof, and outputs the delayed value u_{d} to the first and second neural network units as part of the vector signal μ. The first and second neural networks can further generate adaptive signals \hat{M}_{f}^{T}σ(\hat{N}_{f}^{T}μ) and \hat{M}_{g}^{T}σ(\hat{N}_{g}^{T}μ) based on the delayed value u_{d}.

### BRIEF DESCRIPTION OF THE DRAWINGS

Having thus described the invention in general terms, reference will now be made to the accompanying drawings, which are not necessarily drawn to scale, and wherein:

FIG. 1 is a general block diagram of an embodiment of a control system in accordance with the invention, which uses a linear observer augmented by an adaptive element to produce an adaptive observer to track an observed system in accordance with an embodiment of the invention;

FIG. 2 is a block diagram of a linear error observer of the adaptive observer of FIG. 1 in accordance with an embodiment of the invention;

FIG. 3A is a block diagram of an embodiment of a single hidden layer (SHL) neural network of a first neural network unit of the adaptive observer which is used to generate an adaptive output signal to account for unmodeled dynamics of an observed system in accordance with the invention;

FIG. 3B is a block diagram of an embodiment of a single hidden layer (SHL) neural network of a first neural network unit of the adaptive observer which is used to generate an adaptive output signal to account for unmodeled dynamics and disturbances of an observed system in accordance with the invention;

FIG. 4 is a block diagram of a time delay unit of the adaptive observer which generates delayed versions of the actual output signal y and the control signal u to serve as inputs to the neural networks of the units of FIGS. 3A-3B;

FIG. 5 is a block diagram of a tracking system implemented using a processor which executes a control program to the elements of the tracking system shown and described with respect to FIG. 1;

FIG. 6 is a flow diagram of a method of tracking an observed system in accordance with the invention.

### DETAILED DESCRIPTION OF THE INVENTION

The present invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### GLOSSARY OF TERMS

As used herein, the following terms have the following definitions:

‘Actuator’ can be virtually any device capable of affecting the state of an observed system to control a degree of freedom thereof. Such actuator can be a part of an aircraft, spacecraft, vehicle, ship, robot, machine, or other system to be tracked.

‘Control Cycle’ refers to a single iteration or execution of a software program by a processor implementing a tracking system in generating the various signals required to track and estimate the state of an observed system in accordance with the invention.

‘Dynamics’ refers to changes in the state and output of an observed system, and their relationship.

‘Observed System’ refers to a system under observation. Such system can be an aircraft, spacecraft, vehicle, ship, robot, machine, or other system to be tracked.

‘Processor’ refers to a microprocessor, microcontroller, field programmable gate array, or other device capable of receiving code, data, or both, and processing same to generate an output signal.

‘Sensor’ can be virtually any device(s) for sensing output of an observed system, and may operate alone or in combination with one or more other sensors, to generate a measurement or estimate of an observed system's state. The sensor can be virtually any device suitable for sensing information regarding an observed system's state. For example, the sensor could be a gyroscope for detecting orientation of a vehicle such as an aircraft, i.e., pitch or roll attitudes or side slip. The sensor can also be a temperature or pressure sensor, a position, velocity, or inertial sensor.

‘(s)’ means one or more of the thing meant by the word preceding “(s)”. Thus, ‘control signal(s)’ means ‘one or more control signals.’

### A. General Embodiment of Tracking System Incorporating Adaptive Observer

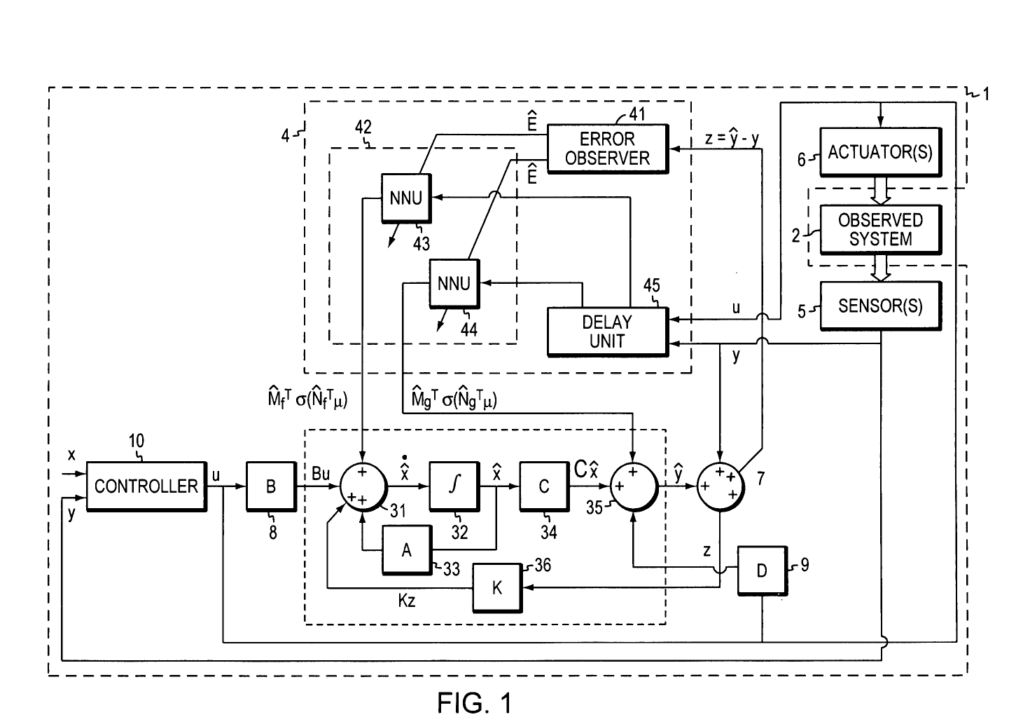

FIG. 1 is a general embodiment of a tracking system 1 for tracking the state of an observed system 2. The tracking system 1 can also be used in the control of the observed system 2, depending upon the application to which the tracking system 1 is applied. Thus, the tracking system 1 can be applied to tracking, and optionally also control, of numerous kinds of observed systems, including automated machines, robots, aircraft, satellites, missiles, rockets, vehicles, or other devices. The tracking system 1 can also be used to track a target such as a star, planet, meteor, weather pattern, environment, etc. The state of the observed system 2 can include variables such as position, attitude, velocity, acceleration, etc. which define the state of the controlled system 2 over time. Those of ordinary skill in the art will thus appreciate that the tracking system 1 has broad application in numerous fields and technologies, including those specifically mentioned above, and others not specifically mentioned.

The tracking system 1 comprises an adaptive observer 2 in accordance with the invention. The adaptive unit 2 comprises a linear observer 3 and an adaptive observer 4. The tracking system 1 can further comprise a sensor 5, actuator 6, node 7, and multipliers 8, 9, as shown in FIG. 1. In addition to the capability of tracking the observed system 2, the system 1 can comprise a controller 10 for generating a control signal to control the observed system 2.

In order to implement the tracking system 1 in accordance with the described embodiments of the invention, the dynamics of the observed system 2 must be an observable and bounded nonlinear process, meaning that the actual output signal y from such system must be a function of all states of the system. The observed system 2 can be defined as follows:
\dot{x}₀=f₀(x⁰,u,v)
y=g₀(x₀,u,v) (1)
in which x₀ is the state of the observed system and is a member of the set Ω₀ which in turn is in the realm of signal values Rⁿ₀, u belongs to the realm of signal values R^{m}, y belongs to the realm of signal values R^{l}, and u is the control signal (i.e., system input) and y is the system output (i.e., measurement) signal, v belongs to the realm of signal values R^{k} is a bounded and unknown disturbance input, f₀( , , , ), g₀( , , , ) are partially known continuous functions, and f₀ satisfies Lipschitz conditions with respect to its arguments, so that the solution to the observed system 2 defined by Equations (1) exits and is unique.

Bounded disturbances are assumed to belong to a class of continuous time functions, describable by:
\dot{x}ᵥ=fᵥ(x₀,xᵥ)
y=gᵥ(x₀,xᵥ) (2)
in which xᵥ belongs to a set Ωᵥ which is has a realm Rⁿ^{ᵥ} of dimension nᵥ. Thus, in viewing the observed system 2 defined by Equations (1), disturbances are treated as unmodeled dynamics.

An additional assumption in implementation of the control system 1 including the linear observer 3 augmented by the adaptive observer 4, as follows:
\dot{x}=\overline{f}(x,u)
y=g₀(x,u) (3)
must be observable with the output y, in which x=[x₀^{T}xᵥ^{T}]^{T} is a member of the set Ωₓ which belongs to a realm Rⁿ, and \overline{f}=└f₀^{T}fᵥ^{T}┘ is a member of the set Ωₓ of the realm Rⁿ, and the signal \overline{f}=[f₀^{T}fᵥ^{T}]^{T} belongs to the realm Rⁿ, and n=n₀+nᵥ. It has been shown in [12] A. J. Calise, B. J. Yang, and J. Craig, Augmentation of an existing linear controller with an adaptive element, American Control Conference, 2002, that the above assumption is violated only under a very restricted set of conditions. Assuming that a linear time invariant (LTI) model for the system dynamics of Equations (3) is available, the following representation of Equations (3) can be made:
   \dot{x}=Ax+Bu+f(x,u)
   y=Cx+Du+g(x,u) (4)
   in which
   f(x,u)=\overline{f}(x,u)−Ax−Bu
   g(x,u)=g₀(x,u)−Cx−Du (5)
are the modeling errors. Assume that for the LTI model:
   \dot{x}ₗ=Axₗ+Bu
   yₗ=Cxₗ+Du (6)
and there exists a linear observer 3
   \hat{\dot{x}}ₗ=A\hat{x}ₗ+Bu+K(yₗ−ŷₗ)
   ŷₗ=C\hat{x}ₗ+Du (7)
such that the states of Equations (7) track the states Equation (6) asymptotically, i.e., \hat{x}ₗ−xₗ goes to zero as time t goes to infinity. The objective is to augment the linear design in Equations (7) with an adaptive observer, such that its solution approximates the solution of Equation (1) with bounded errors. For most physically realizable systems, the matrix D is normally zero.

### B. Linear Observer

The linear observer 3 can be implemented as a linear filter that generates an estimated output signal ŷ for the observed system 2 based on a tracking error signal z. The tracking error signal z represents the difference between the actual output signal y of the observed system and the estimated output signal ŷ of the observed system. If the observed system 2 is a controlled system, the linear observer 3 can also receive a control signal u and use such control signal to generate the estimated output signal ŷ of the observed system 2. The linear observer 3 is configured to implement the signal relationships established by the above Equations (7) in which \hat{\dot{x}} is a signal representing a vector of first derivative(s) with respect to time of the estimated state vector \hat{x} of the observed system which includes all state variables of the controlled system 2; and A, B, C, D, and K are constants. As stated above, these relationships between the signals received and generated by the linear observer 3 have the effect of reducing the difference between the estimated state vector \hat{x} and the actual state vector x to zero as time goes to infinity. One constraint imposed upon the tracking system 1 and observed system 2 is that all actual states x be observable by the actual output system y. Otherwise, accurate tracking of the observed system 2 cannot be assured.

As shown in FIG. 1, the linear observer 3 can be implemented with a summing node 31, integrator 32, multipliers 33, 34, summing node 35, and multiplier 36. The summing node 31 receives feedback signals A\hat{x} and Kz from the integrator 32 and the arithmetic node 7, respectively. The summing node 31 further receives the adaptive signal \hat{M}_{f}^{T}σ(\hat{N}_{f}^{T}μ) from neural network 43 of the adaptive element 42. The summing node 31 adds the received signals A\hat{x}, Bu, Kz and generates the signal \hat{\dot{x}}=A\hat{x}+Bu+K(y−ŷ) plus the adaptive signal \hat{M}_{f}^{T}σ(\hat{N}_{f}^{T}μ). The summing node 31 is coupled to provide the signal A\hat{x}+Bu+K(y−ŷ)+\hat{M}_{f}^{T}σ(\hat{N}_{f}^{T}μ) to the integrator 32. The integrator 32 integrates the estimated state signal \hat{\dot{x}} to produce the estimated state signal \hat{x}. The signal \hat{x} is fed back to the multiplier 33 which multiplies such signal by the constant A and provided to the summing node 31. The integrator 32 is also coupled to supply the signal \hat{x} to the multiplier 34 which multiplies the signal \hat{x} by the constant C to produce the signal C\hat{x}. The multiplier 34 is coupled to supply the signal C\hat{x} to the summing node 35. In addition to the signal C\hat{x}, the summing node 35 receives the adaptive signal \hat{M}_{g}^{T}σ(\hat{N}_{g}^{T}μ). Furthermore, the multiplier 9 receives and multiplies the control signal u by the constant D to generate the control signal Du supplied to the summing node 35. Based on the signal C\hat{x}, the adaptive signal \hat{M}_{g}^{T}σ(\hat{N}_{g}^{T}μ), and the control signal Du, the summing node 35 generates the estimated output signal ŷ. The summing node 35, or more generally, the linear observer 3, is coupled to supply the estimated output signal ŷ to the summing node 7. The summing node 7 receives the actual output signal y from the observed system 2, subtracts the actual output signal y from the estimated output signal y and generates the signal z supplied to the adaptive observer 4 for use in generation of the adaptive signals \hat{M}_{f}^{T}σ(\hat{N}_{f}^{T}μ), \hat{M}_{g}^{T}σ(\hat{N}_{g}^{T}μ). The adaptive observer 4 will now be described in further detail.

### C. Adaptive Observer

The adaptive observer 4 augments the tracking capability, and optionally also the control capability, of the linear observer 3 by observing and generating adaptive tracking error signals provided to the linear observer 3. These adaptive signals account for errors that may affect the ability of the tracking system 1 to accurately observe and track the output of the observed system 2. The source of such tracking errors can be numerous, as those of ordinary skill in the art appreciate. A first source of such errors can be the result from the fact that the design of the linear observer 3 under relationships such as Equations (1) above is in virtually all cases only capable of inexact observation of the actual output signal y of the system 2, i.e., there will be dynamics in the observed system 2 which are not taken into account in the design of the linear observer 3. As a result, the linear observer 3 in virtually all cases generates an inexact estimation of the state \hat{x} of the observed system 2 in order to generate the estimated output signal ŷ. The above-mentioned types of tracking errors result from ‘unmodeled dynamics’ of the observed system 2 which are not taken into account in the linear observer design represented by the above Equations (1). These tracking errors are referenced as ‘modeling errors’ herein, and related variables are signified herein by the subscripts f.

A second source of tracking error can be within the tracking system 1 itself which leads to uncertainty in measurements of the output signal y. The tracking system 1 can thus have inherent errors in it that may make it impossible to perfectly observe the output signal y of the observed system 2. For example, the sensor(s) 5 and other elements of the tracking system 1 may be inherently inaccurate in sensing physical output from the observed system 2, and/or in generating the actual output signal y representing the physical output of the observed system 2. In addition, the actuator(s) 6 and other elements of the tracking system 1 may produce errors through inaccurate response to received signals. Moreover, the physical characteristics of the sensor(s) 5, actuator(s) 6, and other elements of the systems 1, 2 can change over time so that their output varies. For example, the sensor(s) 5, actuator(s) 6, and/or other elements of the tracking system 2 may physically wear, drift, become uncalibrated, etc. over time, thus introducing tracking errors into the system 1. Another source of tracking errors results from disturbances internal or external to the tracking system 1 and the observed system 2. Such disturbances can be environmental in nature, such as a change in temperature, pressure, atmosphere, noise, etc. may have an adverse impact on the ability of the tracking system 1 to accurately determine the output signal y of the observed system 2. For example, changes in temperature and pressure over the course of a day or year may introduce tracking error. A sudden lightning strike may introduce spiking current or noise into the systems 1, 2. Wind, rain, vapor, changes in air pressure, etc. may all have an impact on the tracking system 1 and the observed system 2. All such errors of the foregoing sources and other types known to those of ordinary skill in the art will be referred to herein as ‘disturbances’ which result in inaccuracies in the measurement of the output signal y of the observed system 2, and variables related to correcting for disturbances are denoted by the subscript g in the observer design developed herein.

Following [13] K. Funahashi, On the approximate realization of continuous mappings by neural networks, Neural Networks, 2:183-192, 1989, a function f(x) belonging to the set C, x which is a member of the set D set belong to the realm Rⁿ can be approximated as a single hidden layer (SHL) neural network:
f(x)=M^{T}σ(N^{T}x)+ε(x), ∥ε(x)∥<ε* (8)
in which σ( ) is a vector of squashing functions, its ith component being defined by └σ(N^{T}\overline{x})┘ᵢ=σ(└N^{T}\overline{x}┘ᵢ), ε(x) is the function reconstruction error, and M, N are bounded constant weights. In [14] N. Hovakimyan, H. Lee, and A. Calise, On approximate neural network realization of an unknown dynamic system from its input-output history, American Control Conference, 2000 and [15] E. Lavretsky, N. Hovakimyan, and A. Calise, Reconstruction of construction of continuous-time dynamics using delayed outputs and feedforward neural networks, Submitted to IEEE Transactions on Automatic Control, it has been shown that for observable system such an approximation can be achieved from available input/output history.

It is assumed that for ε_{f}*>0, there exists a set of bounded weights M_{f}, N_{f}, such that f(x,u) in Equations (4), can be approximated over a compact set D belonging to Ωₓ×R^{m} by a SHL neural network
f(x,u)=M_{f}^{T}σ(Nₗ^{T})+ε_{f}(μ), ∥ε_{f}∥<ε_{f}* (9)
using the input vector:
   μ(t)=[1\overline{y}_{d}^{T}(t)\overline{u}_{d}^{T}(t)]^{T}, ∥μ∥≦μ* (10)
in which y_{d}, u_{d} are tapped delayed lines or stored past values of the inputs and outputs of the system.

### C1. Adaptive Observer for Unmodeled Dynamics

To simplify the presentation, assume that g(x, u)=0, i.e., the measurements are known exactly. Then, the dynamics in Equation (4) can be expressed as:
\dot{x}=Ax+Bu+M_{f}^{T}σ(N_{f}^{T}μ)+ε_{f}(μ)
y=Cx+Du (11)

The following adaptive observer is derived through use of Equation (11):
\hat{\dot{x}}=A\hat{x}+Bu+\hat{M}_{f}^{T}σ(\hat{N}_{f}^{T}μ)+K(ŷ−y)
ŷ=C\hat{x}+Du (12)
in which \hat{M}_{f}, \hat{N}_{f} denote the estimates of the optimal weights that will be adjusted online. Notice that this form of the observer can be viewed as a linear observer for the linear portion of the dynamics in Equations (4) augmented with a neural network to map the modeling error f, represented here in the form of Equations (9). By denoting the observation error vectors E=\hat{x}−x, z=ŷ−y, the adaptive observer 4 can be implemented to receive and generate the following signals:
   \dot{E}=\overline{A}E+\hat{M}_{f}^{T}σ(\hat{N}_{f}^{T}μ)−M_{f}^{T}σ(N_{f}^{T}μ)−ε_{f}
   z=CE (13)
in which the signal \dot{E} is the first derivative with respect to time of the observation error vector signal E for the observed system 2. The signal \overline{A} is defined to be A−KC in which the signal K is a design matrix selected by the designer to make A−KC stable. The signal z represents an estimate of the difference between the signals ŷ and y which are the estimated and actual output signals, respectively, from the observed system 2. The signals \hat{M}_{f}^{T}, \hat{N}_{f}^{T} represent estimates of the connection weights of a first neural network represented by \hat{M}_{f}^{T}σ(\hat{N}_{f}^{T}μ). The signal μ represents the vector of Equation (10) that can include the observed output signal y, the control signal u (if the observed system 2 is controlled), and one or more time-delayed versions y_{d} and u_{d} thereof. The signal ε_{f} represents the tracking error attributable to modeling error in the overall systems 1, 2. The subscript f denotes that the related variable is used by the adaptive observer 4 to eliminate tracking error due to modeling error(s) as opposed to a disturbance(s).

To implement the relationships of equations (2), the adaptive observer 4 can comprise error observer 41 and adaptive element 42. The error observer 41 implements a linear observer design according to the following relationships:
\hat{\dot{E}}=\overline{A}Ê+\overline{K}(z−\hat{z})
z=CÊ (14)

The error observer 41 can thus be implemented as a linear filter. The signal \overline{K} is a gain matrix chosen so that the signal \overline{A}=A−\overline{K}C is asymptotically stable. The error observer 41 is coupled to receive the tracking error signal z=ŷ−y from the arithmetic node 7, and generates the estimated adaptive error signal Ê based on the tracking error signal y. If \tilde{E}=Ê−E, then the adaptive observer 4 can be implemented as:
\tilde{\dot{E}}=Ã\tilde{E}−\hat{M}_{f}^{T}σ(\hat{N}_{f}^{T}μ)+M_{f}^{T}σ(N_{f}^{T}μ)+ε_{f} (15)

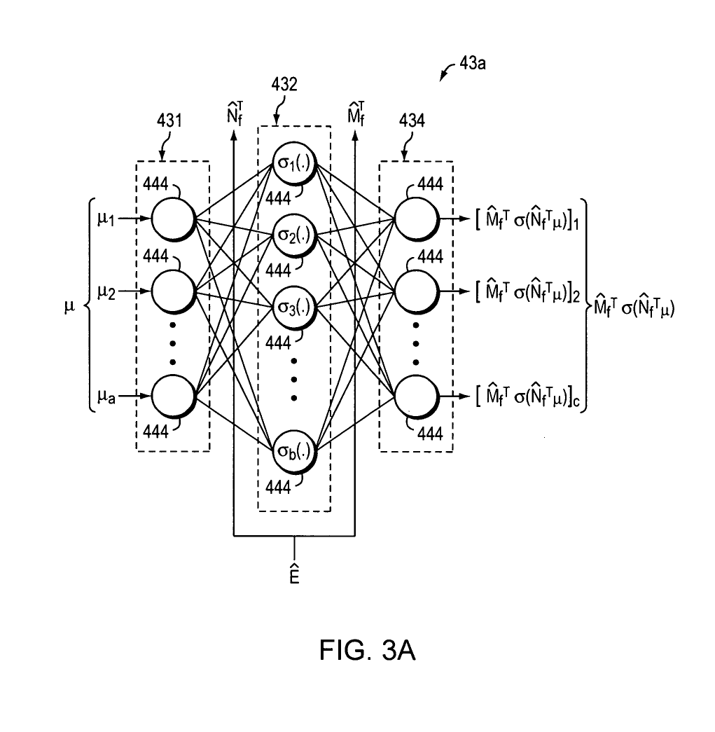

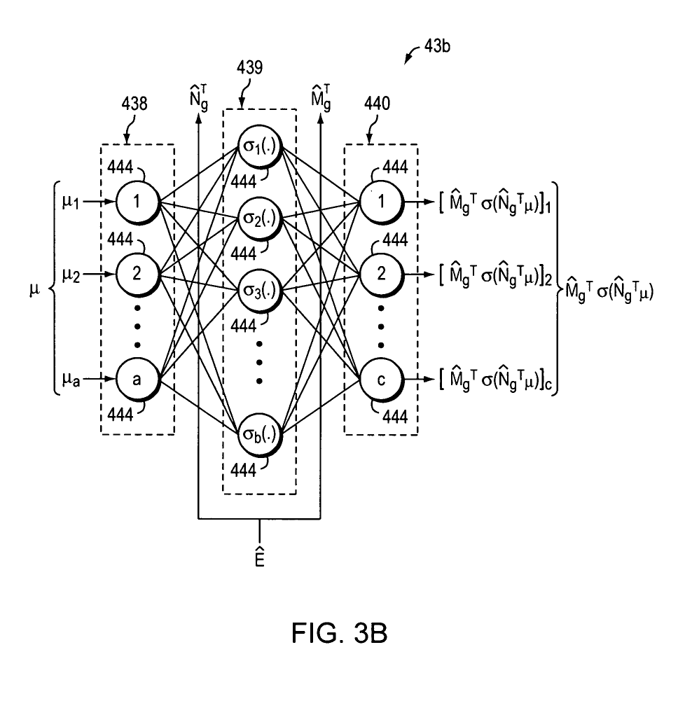

Thus, the adaptive element 42 can be implemented to comprise neural network 43. The neural network 43 can be structured as signal hidden layer (SHL) neural networks with an input layer, hidden layer, and output layer of neurons and sets of connection weights linking the neurons of the input layer to the hidden layer, and the hidden layer to the output layer, as will be described in further detail with respect to FIGS. 3A, 3B. The adaptive element 42, or more particularly, the neural network 43 can be coupled to receive the estimated error signal Ê from the error observer 41 which such neural network 43 uses to update its connection weights \hat{M}_{f}^{T}, \hat{N}_{f}^{T}. The update of estimates for the connection weights \hat{M}_{f}^{T}, \hat{N}_{f}^{T} is performed according to the following relationships:
\hat{\dot{N}}=−G_{f}[2μÊ^{T}P\hat{M}_{f}^{T}\hat{σ}_{f}′+k_{f}(\hat{N}_{f}−N_{f}_{₀})]
\hat{\dot{M}}_{f}=−F_{f}[2(\hat{σ}_{f}−\hat{σ}_{f}′\hat{N}_{f}^{T}μ)Ê^{T}P+k_{f}(\hat{M}_{f}−M_{f}_{₀})] (16)
in which, F_{f}, and G_{f} are adaptation gain matrices each greater than zero, P represents the solution of the Lyapunov equation \overline{A}^{T}P+P\overline{A}=−Q; \hat{σ}_{f} is defined to be \hat{σ}(\hat{N}_{f}μ), \hat{σ}_{f}′ is defined to be \hat{σ}′(\hat{N}_{f}μ) is the Jacobian computed at the estimates \hat{M}_{f}^{T}, \hat{N}_{f}^{T}, the matrices N_{f}_{₀} and \hat{M}_{f}_{₀} are initial values for weights (if available), and the signal k_{f} is a constant adaptation gain greater than zero.

Using the updated connection weights \hat{M}_{f}^{T}, \hat{N}_{f}^{T}, the neural network 43 generates the adaptive signal \hat{M}_{f}^{T}σ(\hat{N}_{f}^{T}μ), in which, as previously described, the signal μ represents a vector that can include the observed output signal y, the control signal u (if the observed system 2 is controlled), and one or more time-delayed signals y_{d} and u_{d} based on respective signals y and u. The adaptive observer 4 can comprise a delay unit 45 to generate the delayed signals y_{d} and u_{d} from the actual output signal y of the observed system 2 and the control signal u from a controller 10 as shown in FIG. 1.

### C2. Adaptive Observer for Unmodeled Dynamics and Nonlinear Disturbances

Returning to the original dynamics, presented in Equations (1), a second NNU 44 is introduced to model the uncertainty in the measurement of Equations (5) as follows:
g(x,u)=M_{g}^{T}σ(N_{g}^{T}μ)+ε_{f}(μ), ∥ε_{g}∥<ε* (17)

The dynamics in Equations (4) can then be set forth as follows:
\dot{x}=Ax+Bu+M_{f}^{T}σ(N_{f}^{T}μ)+ε_{f}(μ)
y=Cx+Du+\hat{M}_{c}^{T}σ(\hat{N}_{g}^{T}μ)+ε_{c}(μ) (18)

The observer for the dynamics in Equations (18) can then be set forth as follows:
\dot{x}=A\hat{x}+Bu+\hat{M}_{f}^{T}σ(\hat{N}_{f}^{T}μ)−K(ŷ−y)
ŷ=C\hat{x}+Du+\hat{M}_{g}^{T}σ(\hat{N}_{g}^{T}μ) (19)
in which \hat{M}_{g}, \hat{N}_{g} are the estimates of the optimal weights to be adapted online. Substituting E=\hat{x}−x, z=ŷ−y into Equations (19) yields the following:
   \dot{E}=\overline{A}E+\hat{M}_{f}^{T}σ(\hat{N}_{f}^{T}μ)−\hat{M}_{f}^{T}σ(N_{f}^{T}μ)−ε_{f}−K[\hat{M}_{g}^{T}σ(\hat{N}_{g}^{T}μ)−M_{g}^{T}σ(N_{g}^{T}μ)−ε_{g}]
   z=CE+\hat{M}_{g}^{T}σ(\hat{N}_{g}^{T}μ)−M_{g}^{T}σ(N_{g}^{T}μ)−ε_{g} (20)
in which the signal \hat{M}_{f}^{T}σ(\hat{N}_{f}^{T}μ) is the output from neural network 43, the signal \hat{M}_{g}^{T}σ(\hat{N}_{g}^{T}μ) is the output from the neural network 44, the signal M_{g}^{T} is the transpose of the vector of connection weights M_{g} for the neural network 43; the signal N_{g}^{T} is the transpose of the vector of connection weights N_{g} for the neural network 43; the signal \hat{M}_{g}^{T} is the transpose of the vector of estimated connection weights \hat{M}_{g} for the neural network 44, and the signal \hat{N}_{g}^{T} is the transpose of the vector of estimated connection weights \hat{N}_{g} of the neural network 44. The signal ε_{g} represents the tracking error attributable to disturbances occurring in the tracking system 1 and the observed system 2.

In Equations (20) above, the connection weights \hat{M}_{g}, \hat{N}_{g} are updated according to the following relationships:
\hat{\dot{M}}_{g}=−F_{g}[2(\hat{σ}_{g}−\hat{σ}_{g}′\hat{N}_{g}^{T}μ)Ê^{T}\overline{P}\overline{K}+k_{g}(\hat{M}_{g}−M_{g}_{₀})]
\hat{\dot{N}}_{g}=−G_{g}[2μÊ^{T}\overline{P}\overline{K}\hat{M}_{g}^{T}\hat{σ}_{g}′+k_{g}(\hat{N}_{g}−N_{g}_{₀})] (21)
in which the signals F_{g} and G_{g} are adaptation gain matrices that are both greater than zero, the signal \hat{σ}_{g} is defined to be σ(\hat{N}_{g}μ), the signal \hat{σ}_{g}′ is defined to be σ′(\hat{N}_{g}μ), the matrices N_{g}_{₀} and M_{g}_{₀} are initial values for weights (if available) and the signal k_{g} is a constant that is greater than zero.

### C3. Error Observer

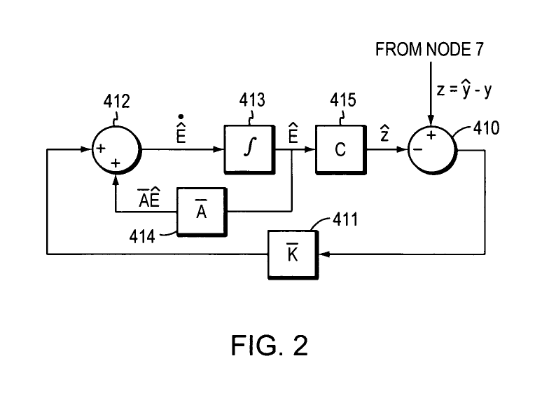

FIG. 2 is a relatively detailed view of an embodiment of the error observer 41 of FIG. 1. The error observer 41 comprises an arithmetic node 410, multiplier 411, summing node 412, integrator 413, multiplier 414, and multiplier 415. The node 410 is coupled to receive the signal z=ŷ−y from the node 7 and the signal \hat{z} from the multiplier 415. The node 410 outputs the signal z−\hat{z} to the multiplier 411 where it is multiplied by the gain \overline{K}. The multiplier 411 outputs the resulting signal to the node 41 at which it is added to the signal \overline{A}Ê to produce the signal \hat{\dot{E}}. The integrator 413 is coupled to receive the estimated adaptive error signal Ê from the integrator 413. The signal Ê is output to the multiplier 414 for use in generating the signal \overline{A}Ê for the next control cycle. In addition, the integrator 413 is coupled to output the signal Ê to the neural network units 43, 44 for use in updating the connection weights thereof. The integrator 413 is also coupled to provide the estimated adaptive error signal Ê to the multiplier 415 for use in generating the signal \hat{z}. The multiplier 415 is coupled to provide the signal \hat{z} to the node 410 for use in the next control cycle.

### C4. Adaptive Element Comprising Neural Networks

FIG. 3A is a relatively detailed schematic view of an embodiment of the neural network 43 for tracking the observed system 2 in the presence of unmodeled dynamics in accordance with Equations (2) and (4) above. The neural network 43 comprises an input layer 431, hidden layer 432, and output layer 434 of neurons 444. The neurons 444 of the input layer 431 are coupled to receive the signal μ, which is a vector comprising the actual output signal y of the observed system 2, the control signal u (if any such signal is used), and delayed versions y_{d}, u_{d} of one or both of these signals. As shown in FIG. 3A, the vector elements of the signal μ (μ₁, μ₂, . . . , μₐ; a is a positive integer representing the number of components in the vector signal μ) are input to respective neurons 444 of the input layer 431 of the neural network 43. The components of the signal μ (μ₁, μ₂, . . . , μₐ) are then output from the input layer 431 and multiplied by respective connection weights \hat{N}_{f}^{T} which have been updated based on the adaptive error signal Ê according to the signal relationships established in Equations (4) above. The resulting output is provided to the hidden layer 432 which comprises neurons 444 implementing basis functions σ so that the output of the hidden layer 432 is the signal vector σ(\hat{N}_{f}^{T}μ) ([σ(\hat{N}_{1f}^{T}μ)]₁, [σ(\hat{N}_{2f}^{T}μ)]₂, . . . , [σ(\hat{N}_{bf}^{T}μ)]_{b}; b a positive integer denoting the number of basis-function neurons). The components of the signal σ(\hat{N}_{f}^{T}μ) are output from the hidden layer 432 and are multiplied by connection weights \hat{M}_{f}^{T} to produce the signal \hat{M}_{f}^{T}σ(\hat{N}_{f}^{T}μ) ([\hat{M}_{f}^{T}σ(\hat{N}_{f}^{T}μ)]₁, [\hat{M}_{f}^{T}σ(\hat{N}_{f}^{T}μ)]₂, . . . , [\hat{M}_{f}^{T}σ(\hat{N}_{f}^{T}μ)]_{c}). The connection weights \hat{M}_{f}^{T} are modified based on the adaptive error signal Ê according to relationships defined by Equations (16) above before multiplication with the components of the signal σ(N_{f}^{T}μ) The neurons 444 of the output layer 434 receive and output the vector signal \hat{M}_{f}^{T}σ(\hat{N}_{f}^{T}μ) ([\hat{M}_{f}^{T}σ(\hat{N}_{f}^{T}μ)]₁, [\hat{M}_{f}^{T}σ(\hat{N}_{f}^{T}μ)]₂, . . . , [\hat{M}_{f}^{T}σ(\hat{N}_{f}^{T}μ)]_{c}) as the output of the neural network 43.

FIG. 3B is a relatively detailed schematic view of an additional component of the neural network 44 in the case of tracking the observed system 2 for unmodeled dynamics and disturbances, possibly nonlinear, in accordance with equations (18) above. The neural network 43 comprises an input layer 438, hidden layer 439, and output layer 440 of neurons 444. The neurons 444 of the input layer 438 are coupled to receive the signal μ, which is a vector comprising the actual output signal y of the observed system 2, the control signal u (if any is used), and optionally delayed versions y_{d}, u_{d} of one or both of these signals. As shown in FIG. 3A, the vector elements of the signal μ (μ₁, μ₂, . . . , μₐ; a is a positive integer representing the number of components in the vector signal μ) are input to respective neurons 444 of the input layer 438 of the neural network 43. The components of the signal μ (μ₁, μ₂, . . . , μₐ) are then output from the input layer 438 and multiplied by respective connection weights \hat{N}_{g}^{T} which have been updated based on the adaptive error signal Ê according to the signal relationships defined in Equations (7) above. The resulting output is provided to the hidden layer 439 which comprises neurons 444 implementing basis functions σ so that the output of the hidden layer 439 is the signal vector σ(\hat{N}_{g}^{T}μ) ([σ(\hat{N}_{g}^{T}μ)]₁, [σ(\hat{N}_{2g}^{T}μ)]₂, . . . , [σ(\hat{N}_{g}^{T}μ)]_{b}), in which b a positive integer representing the number of basis-function neurons. The components of the signal σ(\hat{N}_{g}^{T}μ) are output from the hidden layer 432 and are multiplied by connection weights \hat{M}_{g}^{T} to produce the signal \hat{M}_{g}^{T}σ(\hat{N}_{g}^{T}μ) ([\hat{M}_{g}^{T}σ(\hat{N}_{g}^{T}μ)]₁, [\hat{M}_{g}^{T}σ(\hat{N}_{g}^{T}μ)]₂, . . . , [\hat{M}_{g}^{T}σ(\hat{N}_{g}^{T})]_{c}). The connection weights \hat{M}_{g}^{T} are modified based on the adaptive error signal Ê according to relationships defined by Equations (18) above before multiplication with the components of the signal σ(N_{g}^{T}μ) The neurons 444 of the output layer 434 receive and output the vector signal \hat{M}_{g}^{T}σ(\hat{N}_{g}^{T}μ) ([\hat{M}_{g}^{T}σ(\hat{N}_{g}^{T}μ)]₁, [\hat{M}_{g}^{T}σ(\hat{N}_{g}^{T}μ)]₂, . . . , [\hat{M}_{g}^{T}σ(\hat{N}_{g}^{T}μ)]_{c}) as an output of the neural network 43 in combination with the output of the neural network 43 described with reference to FIG. 3A. The summing node used to combine these signals to generate the final output of the neural network 43 will be described with reference to FIG. 3E.

### C5. Time Delay Unit

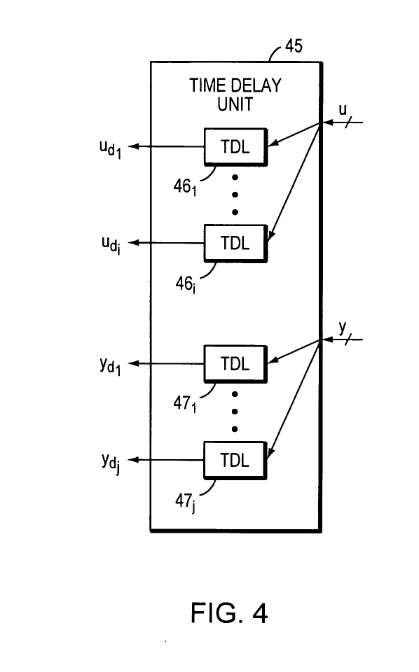

FIG. 4 is a block diagram of a time delay unit 45 of the tracking system 2 in accordance with FIG. 1. The time delay unit 45 can be implemented as signal path delays or a memory or buffer which stores current and past values of the control signal u (if used in the control system 1) and the actual output signal y from the observed system 2. The time delay unit 45 is coupled to receive the control signal u (if any) from the controller 10, and the actual output signal y from the sensor(s) 5. The time delay unit 45 generates time-delayed values u_{dl}, . . . , u_{di} of the control signal u (assuming of course that such signal is used in the tracking system 1) using delay elements 46₁, . . . , 46ᵢ, in which i is a positive integer representing the number of time delay elements 46. Furthermore, the time delay unit 45 can comprise time-delay elements 47₁, . . . , 47ⱼ to generate respective signals y_{dl}, . . . , y_{dj} in which j is the number of time delay elements 47₁, . . . , 47ⱼ. and corresponding delayed signals. The time delay elements can be provided as inputs to the adaptive element 42, or more specifically, the neural network units 43, 44 thereof. Ordinarily, the time increment between successive outputs will equal. Thus, for example, in an exemplary embodiment, the signals u_{dl}, y_{dl} can be delayed by 0.001 seconds from the current values of the signals u, y, the signals u_{ds}, y_{ds} can be delayed by 0.002 seconds from the current values of the signals U, y, u_{d3}, y_{d3} can be delayed by 0.003 seconds from the current values of the signals u, y, and so on. In one embodiment, the time delay unit 45 can be implemented by sampling the signals u, y and storing these samples in a buffer or memory. Alternatively, the time delay elements 46₁, . . . , 46ᵢ and 47₁, . . . , 47ⱼ can be implemented as delay taps, signal path delay (e.g., delay lines or circulators), or other such elements. The use of the delayed signals u_{dl}, . . . , u_{di} and y_{dl}, . . . , y_{dj} helps to ensure that relevant states of the observed system 2 can be determined.

### C6. Controller

The controller 10 can be implemented in numerous ways, as is apparent to those of ordinary skill in the art. In one embodiment, the controller 10 can be configured to receive the actual state signal x and the actual output signal y for use in generating the control signal u. The controller 10 can be implemented as a proportional-derivative (PD) or proportional-integral-derivative (PID) controller, for example. The controller 10 can involve a human operator in which case the signals x, y are used to generate a display or other human-perceptible output, and based on such output, the human operator uses control elements (e.g., a stick, foot pedals, etc.), to generate the control signal u through a command filter. Alternatively, the controller 10 can be automated, in which case interfaces otherwise required for human interaction with the controller 10 can be omitted.

### C7. Implementations of Tracking System

Those of ordinary skill in the art will recognize that the tracking system 2 can be implemented in various ways. For example, the tracking system 2 can be implemented digitally as a computer or processor executing a software program. Alternatively, the elements of the tracking system 2 such as the linear observer 3 and adaptive observer 4 can be implemented as analog elements or hardwired logic, for example.

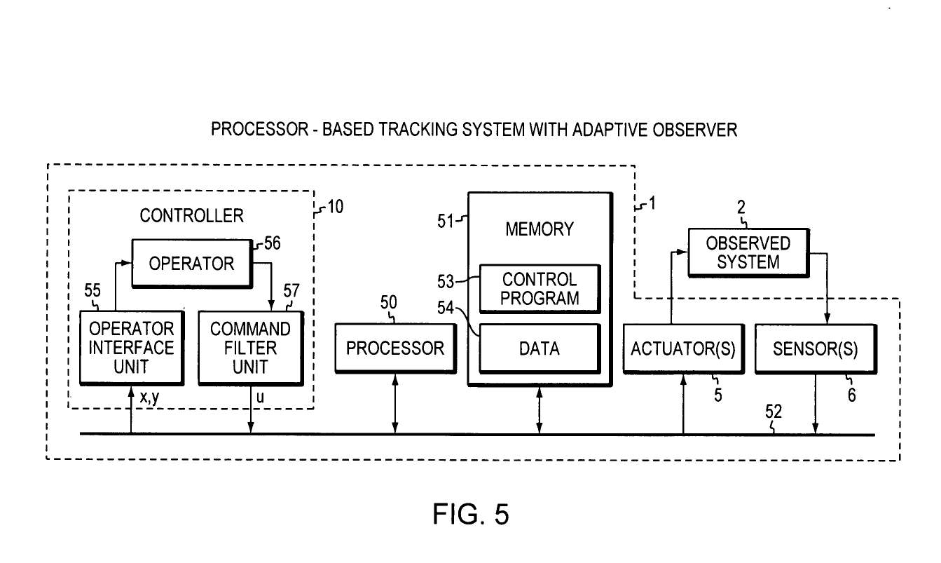

FIG. 5 is a block diagram of an exemplary embodiment of the tracking system 1 comprising a processor 50, a memory 51, a sensor(s) 5, and in an optional embodiment, an actuator(s) 6 and controller 10, which are coupled so that the processor 50 can receive and transmit signals to and from such other elements via bus 52. The processor 50, memory 51, sensor 5, actuator 6, and controller 10 are coupled to permit the processor 50 to communicate with such other elements via the bus 52.

The memory 51 stores a control program 53 and data 54. The control program 53 stores software which has modules corresponding to the elements of the system 1 shown in FIG. 1. Thus, the control program 53 implements the linear observer 3 and the adaptive observer 4, the node 7, and the multipliers 8, 9. The data 54 can include stored information such as constants and vector arrays A, B, C, D, K, current and delayed or past values of the signals \hat{\dot{x}}, \hat{x}, ŷ, y, y_{d}, z, u, u_{d}, Ê, M_{f}^{T}, N_{f}^{T}, \hat{M}_{f}^{T}, \hat{N}_{f}^{T}, M_{g}^{T}, N_{g}^{T}, \hat{M}_{g}^{T}. \hat{N}_{g}^{T}, etc. The data 54 can also comprise libraries and utilities, as is well known to persons of ordinary skill in this art. Furthermore, the memory 51 can store an operating system and communication interface software (e.g., TCP/IP or Ethernet stacks) (not shown) or the like to enable the processor to communicate with other elements of the system 1 via the bus 52.

In operation, the processor 50 executes its control program 53 to receive the output signal y from the sensor 6 via the bus 52. It implements the function of node 7 by subtracting the actual output signal y from the estimated output signal ŷ to produce the tracking error signal z. It further implements the function of the multiplier 36 by multiplying the tracking error signal z by the constant K for use in a subsequent control cycle. The processor 50 executes the control program 53 to generate the state signal x based on the received actual output signal y. The processor 50 further executes the control program 53 to provide the actual state signal x and the actual output signal y to the controller 10 via the bus 52.

The controller 10 comprises an operator interface unit 55, a controller 56 (in embodiments in which it is a processor-based machine and not a human), and a command filter unit 57. The operator interface unit 55 is coupled to the bus 52 to receive the actual state signal x and the actual output signal y from the processor 50. Based on the signals x, y, the operator interface unit 55 generates an interface signal which is usable by the operator 56. In the case in which the operator 56 is human, the interface signal can be displayed to the operator 56 as a display or other indicator that enables the operator 56 to understand the state and output of the observed system 2. Alternatively, if the operator 56 is a processor-based machine, then the interface signal is a signal that can be used by the operator 56. Based on the interface signal, the operator 56 produces a control action or signal (e.g., movement of a stick, foot pedals, etc., or generation of a signal via a process of the machine version of the operator 56). The operator 56 is coupled to provide such command action or signal to the command filter unit 57 which generates the control signal u based thereon. The command filter unit 57 is coupled to supply the control signal u to the processor 50 and the actuator(s) 6 via the bus 52. The command filter unit 57 may thus provide the control signal u directly to the actuator(s) 6, or the control signal u may be received by the processor 50 and translated into one or more signals with format suitable for control of the actuator(s) 6. For example, the processor 50 and memory 51 may be considered a flight control system or guidance system in which the control signal u is received and converted into control signals output via bus 52 to the actuator(s) 5 to move control surfaces such as ailerons, rudders, thrust vector actuators, fuel flow valves, etc., in order to affect control of the observed system 2.

The processor 50 further executes the control program 53 to perform the function of the error observer 41 to generate the estimated adaptive error signal Ê. The processor 50 continues execution of the control program 53 by using the estimated adaptive error signal Ê to update the connection weights M_{f}^{T}, N_{f}^{T}, \hat{M}_{f}^{T}, \hat{N}_{f}^{T} of the neural network units 43, 44. The control program 53 can be implemented to generate the connection weights M_{f}^{T}, N_{f}^{T}, \hat{M}_{f}^{T}, \hat{N}_{f}^{T} according to the update rules defined by either Equations (16) or (21). The processor 50 further stores the current values of the actual output signal y and the control signal u in the memory 51 as data 54. The processor 50 retrieves delayed or past values y_{d}, u_{d} of the actual output signal y and control signal u, and provides these signals y_{d}, u_{d}, optionally along with the signals y, u, to the neural network units 43, 44 as inputs thereto. Based upon the received estimated adaptive error signal Ê and the connection weights \hat{M}_{f}^{T}, \hat{N}_{f}^{T}, the processor 50 executes the control program 53 to carry out the processing of the neural network unit 43, resulting in the adaptive signal \hat{M}_{f}^{T}σ(\hat{N}_{f}^{T}μ) whether the adaptive observer 4 is implemented according to the relationships of either Equation (16) or (21) depending upon which embodiment is used. Also, based upon the received adaptive error signal Ê and the connection weights \hat{M}_{g}^{T}, \hat{N}_{g}^{T}, the processor executes the control program 53 to implement the function of the neural network unit 44, to generate the adaptive signal \hat{M}_{g}^{T}σ(\hat{N}_{g}^{T}μ) using the connection weights defined in the previous control cycle.

The processor 50 continues the execution of the control program 53 by implementing the function of the multiplier 8 by multiplying the control signal u by the vector signal B which the processor retrieves from memory 51. Further, the processor 50 implements the function of the multiplier 36 by multiplying the signal z by the vector signal K retrieved from the data 54 in its memory 51. The processor 50 further executes the control program 53 to implement the functions of the summation node 31 by adding the signal Bu, the signal Kz, the signal A\hat{x} retrieved from data 54 in the memory 51, and the adaptive signal \hat{M}_{f}^{T}σ(\hat{N}_{f}^{T}μ) from the neural network unit 43, and sums these signals to generate the signal \hat{\dot{x}}. The processor 50 further executes the control program to implement the function of the integrator 32 to integrate the signal \hat{\dot{x}}, resulting in the signal \hat{x}. The processor 50 further executes the control program 53 to implement the function of multiplier 33 by multiplying the signal \hat{x} by the vector signal A and storing the result as data 54 in the memory 51 for use in the subsequent control cycle. The processor 50 further executes the control program 53 to implement the function of the multiplier 4 by multiplying the signal \hat{x} by the matrix C, resulting in the signal C\hat{x}. The processor 50 further executes the control program 53 to implement the function of the node 35 by adding the signal C\hat{x} to the signal \hat{M}_{g}^{T}σ(\hat{N}_{g}^{T}μ) to produce the signal ŷ to be used in the next control cycle.

A complete cycle through the above described operations executed by the processor 50, and optionally also the controller 10, is referred to as a ‘control cycle.’ The processor 50, and optionally the controller 10, can be programmed to repeat the control cycle starting with an updated value for the actual output control signal y through generation of the estimated output signal ŷ for the next control cycle. The tracking system 1 repeats the control cycle periodically or at various times as often as is necessary in order to track the state of the observed system 2. For an advanced aircraft, the control cycle can be from nanoseconds to milliseconds, for example.

### D. Inventive Methods

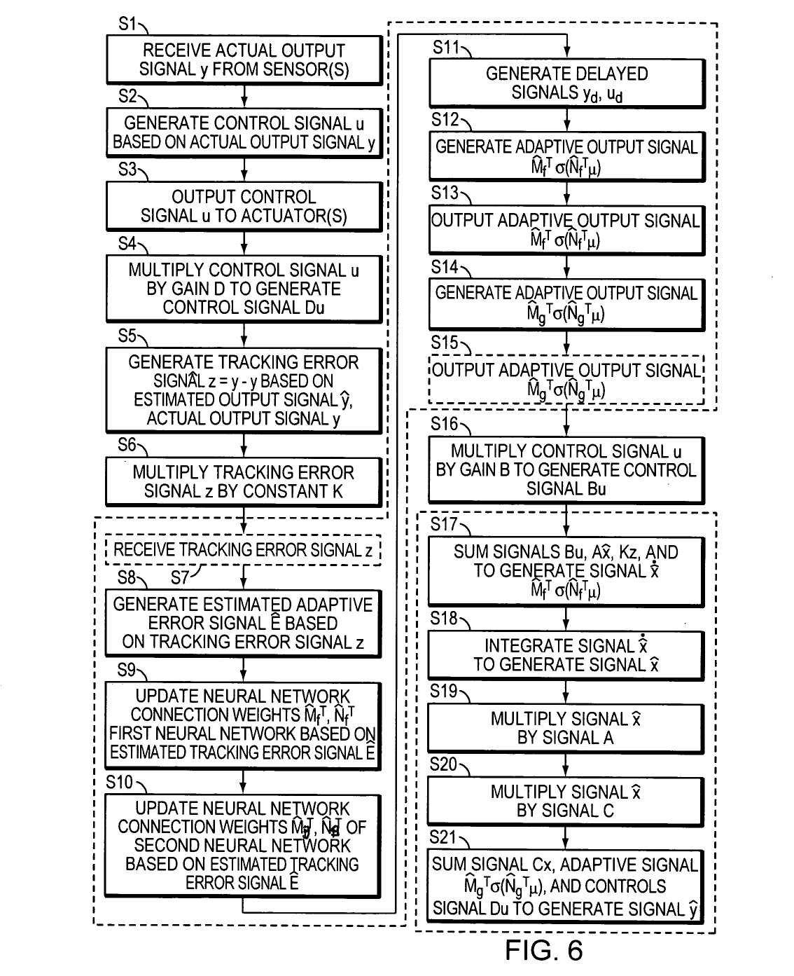

FIG. 6 is a flow chart of processing performed by the system 1 in accordance with the invention. In Step S1 the summing node 7, delay unit 45, and controller 10 receive the actual output signal y from the sensor(s) 5 responsive to the physical output of the observed system 10. Constraints are such that the entire state of the observed system 2 must be observable from the actual output signal y. In Step S2 the controller 10 generates the control signal u based on the actual output signal y, and optionally also based on the actual state signal x derived from the signal y using one of a variety of methods well known to those of ordinary skill in the art. In Step S3 the controller 10 outputs the control signal u to the actuator(s) 6, causing the actuator(s) to affect control of the observed system 10. In Step S4 the multiplier 9 receives and multiplies the control signal u by the gain matrix D to produce the control signal Du. In Step S5 the summing node 7 receives the estimated output signal ŷ, and generates the tracking error signal z=ŷ−y by subtracting the estimated output signal ŷ and the actual output signal y. In Step S6, the multiplier 36 receives and multiplies the tracking error signal z by the constant matrix K to produce the signal Kz to be used in a step yet to be described.

Steps S7-S15 are executed by the adaptive observer 4. In Step S7 the tracking error signal z is received by the adaptive observer 4. This is an optional step used when the adaptive observer 4 is implemented as a discrete element as opposed to an embodiment such as that of FIG. 5 in which the adaptive observer 4 is implemented as a module of the control program 53 executed by the processor 50 which may not require transmission and reception of data 54 that is stored in its memory 51. In Step S8 the error observer 41 generates the estimated adaptive error signal Ê based on the tracking error signal z. In Step S9 the neural network unit 43 receives the estimated adaptive tracking error signal Ê and uses this signal to update its connection weights \hat{M}_{f}^{T}, \hat{N}_{f}^{T}. In Step S10 the neural network unit 44 receives the estimated adaptive tracking error signal Ê and uses this signal to update its connection weights \hat{M}_{g}^{T}, \hat{N}_{g}^{T}. In Step S11 the time delay unit 45 of the adaptive observer 4 generates delayed actual output signal y_{d} and delayed control signal u_{d}, based on respective signals y, u. Depending upon implementation, this may involve delaying the signals through a signal path, or alternatively, merely retrieving data for previous control cycles from a memory. In Step S12 the neural network unit 43 of the adaptive observer 4 generates an adaptive signal \hat{M}_{f}^{T}σ(\hat{N}_{f}^{T}μ) based on the updated connection weights \hat{M}_{f}^{T}, \hat{N}_{f}^{T} and the delayed actual output signal y_{d} and delayed control signal u_{d} (if any), and optionally also on respective signals y, u. In Step S13 the neural network unit 43 outputs the adaptive output signal \hat{M}_{f}^{T}σ(\hat{N}_{f}^{T}μ). This is an optional step in the implementation in which the neural network unit 43 is an element discrete and separate from the linear observer 3. In Step S14 the neural network unit 44 generates the adaptive output signal \hat{M}_{g}^{T}σ(\hat{N}_{g}^{T}μ) based on the updated connection weights \hat{M}_{g}^{T}, \hat{N}_{g}^{T} and the delayed actual output signal y_{d} and delayed control signal u_{d} (if any), and optionally also on respective signals y, u. In optional Step 15, the neural network unit 44 outputs the adaptive output signal \hat{M}_{g}^{T}σ(\hat{N}_{g}^{T}μ). The step is optional because, an embodiment such as FIG. 5, the adaptive output signal need not actually be output from the memory 51 in order to be accessible to the module of the control program 53 that is used to implement the linear observer 3.

In Step S16 the control signal u is multiplied by the gain matrix B to generate control signal Bu. Steps S17-S21 are implemented by the linear observer 3. In Step S17 the node 31 receives the adaptive output signal \hat{M}_{f}^{T}σ(\hat{N}_{f}^{T}μ), and the signals Bu, A\hat{x}, and Kz, and generates the signal \hat{x} based thereon. In Step S18 the integrator 32 integrates the signal \hat{\dot{x}} to produce the signal \hat{x}. In Step S19 the multiplier 33 receives and multiplies the signal \hat{x} by the constant matrix A. In Step S20 the signal \hat{x} is received by the multiplier 34 and multiplied by the constant matrix C to produce the signal C\hat{x}. In Step S21 the signal C\hat{x}, the signal Du, and the adaptive output signal \hat{M}_{g}^{T}σ(\hat{N}_{g}^{T}μ) are received by the node 35 and summed to produce the estimated output signal ŷ.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An adaptive observer comprising:
an error observer coupled to receive a tracking error signal z that is a difference between an estimated output signal ŷ and an actual output signal y of an observed system, the error observer generating an estimated adaptive error signal Ê based on the tracking error signal z;
a first neural network unit coupled to receive the estimated adaptive error signal Ê and adjusting its input and output connection weights \hat{M}_{f}^{T}, \hat{N}_{f}^{T} based on the estimated adaptive error signal Ê;
a second neural network unit coupled to receive the estimated adaptive error signal Ê and adjusting its input and output connection weights \hat{M}_{g}^{T}, \hat{N}_{g}^{T} based on the estimated adaptive error signal Ê; and
a time delay unit coupled to receive the actual output signal y and generating at least one delayed value y_{d} of at least the actual output signal y which the time delay unit provides as a vector signal μ to the first and second neural network units as inputs,
the first and second neural network units generating respective adaptive signals \hat{M}_{f}^{T}σ(\hat{N}_{f}^{T}μ) and \hat{M}_{g}^{T}σ(\hat{N}g^{T}μ) based on the vector signal μ and respective connection weights \hat{M}_{f}^{T}, \hat{N}_{f}^{T}, \hat{M}_{g}^{T}, \hat{N}_{g}^{T}.

2. An adaptive observer as claimed in claim 1 wherein the error observer is implemented as a linear filter.

3. An adaptive observer as claimed in claim 1 wherein the first and second neural network units each comprise nonlinearly parameterized neural networks.

4. An adaptive observer as claimed in claim 1 wherein the connection weights \hat{M}_{f}^{T}, \hat{N}_{f}^{T}, \hat{M}_{g}^{T}, \hat{N}_{g}^{T} are adjusted on line as the adaptive observer is used to observe the observed system.

5. An adaptive observer as claimed in claim 1 wherein the adaptive observer is coupled to augment a linear observer to improve the performance of the linear observer in the presence of nonlinearity in the observed system.

6. An adaptive observer as claimed in claim 1 wherein the time delay unit further receives a control signal u, generates at least one delayed value u_{d} thereof, and outputs the delayed value u_{d} to the first and second neural network units as part of the vector signal μ.

7. A method comprising the steps of:
receiving at an error observer a tracking error signal z that is a difference between an estimated output signal ŷ and an actual output signal y of an observed system;
generating at the error observer an estimated adaptive error signal Ê based on the tracking error signal z;
updating input and output connection weights \hat{M}_{f}^{T}, \hat{N}_{f}^{T} of a first neural network unit based on the estimated adaptive error signal Ê;
updating input and output connection weights M_{f}^{T}, N_{f}^{T} of a second neural network unit based on the estimated adaptive error signal Ê;
generating a delayed value y_{d} of at least the actual output signal y which the time delay unit provides as a vector signal μ to the first and second neural network units as inputs;
generating adaptive signals \hat{M}_{f}^{T}σ(\hat{N}_{f}^{T}μ) and \hat{M}_{g}^{T}σ(\hat{N}_{g}^{T}μ) at the first and second neural network units based on the delayed value y_{d}; and
outputting the adaptive signals \hat{M}_{f}^{T}σ(\hat{N}_{f}^{T}μ) and \hat{M}_{g}^{T}σ(\hat{N}_{g}^{T}μ) to a linear observer that observes the observed system.

8. A method as claimed in claim 7 wherein the estimated adaptive error signal Ê is generated by linearly filtering the tracking error signal z.

9. A method as claimed in claim 7 wherein the first and second neural network units updating respective connection weights \hat{M}_{f}^{T}, \hat{N}_{f}^{T}, \hat{M}_{g}^{T}, \hat{N}_{g}^{T} each comprise nonlinearly parameterized neural networks.

10. A method as claimed in claim 7 wherein the connection weights \hat{M}_{f}^{T}, \hat{N}_{f}^{T}, \hat{M}_{g}^{T}, \hat{N}_{g}^{T} are updated on line as the observed system is under observation.

11. A method as claimed in claim 7 wherein the adaptive signals \hat{M}_{f}^{T}σ(\hat{N}_{f}^{T}μ) and \hat{M}_{g}^{T}σ(\hat{N}_{g}^{T}μ) are output to a linear observer to augment the linear observer to improve its performance in the presence of nonlinearity in the observed system.

12. A method as claimed in claim 7 wherein the time delay unit further receives a control signal u, generates at least one delayed value u_{d} thereof, and outputs the delayed value u_{d} to the first and second neural network units as part of the vector signal μ, the first and second neural networks further generating adaptive signals \hat{M}_{f}^{T}σ(\hat{N}_{f}^{T}μ) and \hat{M}_{g}^{T}σ(\hat{N}_{g}^{T}μ) based on the delay value u_{d}.

13. An apparatus comprising:
an adaptive observer having an adaptive element augmenting a linear observer to enhance its ability to track a nonlinear system, the adaptive element comprising at least one of first and second nonlinearly parameterized neural network units, the inputs and output layer weights of which can be adapted on line.

14. An apparatus as claimed in claim 13 wherein the adaptive observer generates the neural network units' teaching signal by an additional linear error observer of the nominal observed system's error dynamics.

15. An apparatus as claimed in claim 13 wherein the adaptive observer has the ability to track an observed system in the presence of unmodeled dynamics and disturbances.

16. An apparatus as claimed in claim 13 wherein the adaptive observer comprises a delay element incorporated in the adaptive element in order to provide delayed values of an actual output signal and a control signal to the neural network units.
